(19) United States
(12) Patent Application Publication
(10) Pub. No.: US 2008/0188263 A1
(43) Pub. Date: Aug. 7, 2008

(54) Device Including a Physical Interface, Memory Module and Wireless Module

(76) Inventor: James Stuart Taylor, Southampton (GB)

Correspondence Address: IBM CORPORATION;INTELLECTUAL PROPERTY LAW, 11400 BURNET ROAD, AUSTIN, TX, 78758, US

(21) Appl. No.: 11/755,051

(22) Filed: May 30, 2007

(30) Foreign Application Priority Data
Feb. 1, 2007 (GB) 07101583.8

(51) Int. Cl. H04B 1/38

(52) U.S. Cl. 455/557

(57) ABSTRACT

A device comprises a physical interface, a memory module and a wireless module. The memory module comprises a first memory interface, a second memory interface and a storage component. The physical interface is connected to the first memory interface and arranged to support access to the storage component and the wireless module is connected to the second memory interface and arranged to support access to the storage component. In a preferred embodiment, the device is arranged such that the access to the wireless module via the physical interface is not possible.

### BACKGROUND OF THE INVENTION

1. Field of the Invention

This invention relates to a device and to a method of operating a device. The device is able to provide automatic updates to non-aware digital devices using wireless networking.

2. Description of the Related Art

There are many mobile devices available today that store data using a memory card. Examples of these devices are mobile phones, digital picture frames, digital cameras and MP3 players (both personal and car head units now have memory card slots). Increasingly these devices are providing a wireless network access method such as Bluetooth or 802.11 wireless networking; older versions offered infrared. There are, however, a lot of devices that still only offer an access method by cable or by removing the memory card and plugging it into a computer, or into a reader attached to a computer. For example, many digital cameras use a memory card that can only be read by being removed from the camera, or via a USB cable attached to the camera.

Wireless cards for mobile devices, shaped to fit in memory card slots have been available for about several years. Memory cards themselves have been available for more years than this. There are even for sale dual cards that are both memory cards and wireless network cards (but still separate devices combined). Existing wireless cards require the knowledge and compatibility of the host device. For them to function, some firmware or software has to be installed onto the machine. The wireless card itself may also have some memory on it, however the wireless technology of the card is totally independent and cannot access the memory. Dual cards would be used as two independent devices by the host device.

It is therefore an object of the invention to improve upon the known art.

### SUMMARY OF THE INVENTION

According to a first aspect of the present invention, there is provided a device comprising a physical interface, a memory module and a wireless module, the memory module comprising a first memory interface, a second memory interface and a storage component, the physical interface connected to the first memory interface and arranged to support access to the storage component, the wireless module connected to the second memory interface and arranged to support access to the storage component.

According to a second aspect of the present invention, there is provided a method of operating a device, the device comprising a physical interface, a memory module and a wireless module, the memory module comprising a first memory interface, a second memory interface and a storage component, the method comprising the steps of accessing the storage component of the memory module through the physical interface and the first memory interface of the memory module, and accessing the storage component of the memory module through the wireless module and the second memory interface.

Owing to the invention, it is possible to provide a device, such as a memory card, that has a wireless function but appears to any receiving (host) device to be a standard memory card. The memory of the device is accessible by the receiving device, in the conventional way, through the physical interface. In addition, the device includes a second memory interface that is accessible via the wireless function, which allows data to be read and/or written to the memory in a wireless manner. This design brings the advantages of wireless networking to the numerous legacy items (such as digital cameras), which do not support wireless networking, because they do not have the requisite software or any ability to update or amend the software run by that legacy device.

The device of the invention is totally different from existing technologies because it is independent to the host device. The host device sees it only as a memory card. Within the device is wireless technology allowing the device to join a wireless network and provide shared secure access to that same memory. This allows the storage area, within the device, to be updated (or read from) remotely.

As all the wireless technology and firmware/processing is internal to the device there is no need to install any software or firmware onto the host device. This allows the device of the invention to be used with any machine that has a memory card slot of the selected type (the invention could be implemented on any card technology). Examples of legacy devices that will benefit from the invention include digital picture frames, digital cameras, MP3 players, car stereos, and DVD players.

The invention is a device that combines the two functions of a memory card and wireless networking and also implements, for example, Windows networking/SAMBA in hardware. This makes the storage space on the card a network share for remote update. The host device itself doesn't need to be aware of this upgrade.

Preferably, the device is arranged such that access to the wireless module via the physical interface is not possible. By isolating the wireless module within the device from the physical interface that connects to the host device, this embodiment of the device will be compatible with any legacy device that can receive card of the specific standard, without any danger that errors will occur on the host device as a result of connecting to the wireless module.

Advantageously, the device further comprises a configuration file stored by the storage component, the configuration file comprising information defining the access through the wireless module to the storage component. The provision of this file on the device supports access control through the wireless module ensuring security and integrity of data. For example, a memory card according to the invention can be inserted into a normal card reader to access the text file stored in its memory. This file is used to set the options used by the wireless and file sharing technologies of the card.

Ideally, the access to the storage component through the wireless module and the second memory interface is a read/write access. In this way the accessing of the storage component within the memory on the device can be such that new files or data etc. can pushed onto the device for the host device to access, and also files can deleted or copied from the memory by a remote device through the wireless module. Preferably, the wireless module comprises a wireless processor, the wireless processor arranged to manage wireless network participation. This allows the device to carry out such functions as polling for suitable remote devices with which to communicate, and therefore to pull files from the remote device or to execute a synchronization function, for example.

### BRIEF DESCRIPTION OF THE DRAWINGS

Embodiments of the present invention will now be described, by way of example only, with reference to the accompanying drawings, in which:—

FIG. 1 is a schematic diagram of an exemplary device used in an illustrative embodiment of the invention,

FIG. 2 is an exemplary schematic diagram of the device of FIG. 1 in use in a host device, and communicating with a wireless enabled computer in an illustrative embodiment of the invention,

FIG. 3 is an exemplary schematic diagram of the computer of FIG. 2, illustrating a card reader receiving the device of FIG. 1, and

FIG. 4 is an exemplary diagram illustrating communications between the computer, the device and the host device.

### DETAILED DESCRIPTION OF THE PREFERRED EMBODIMENT

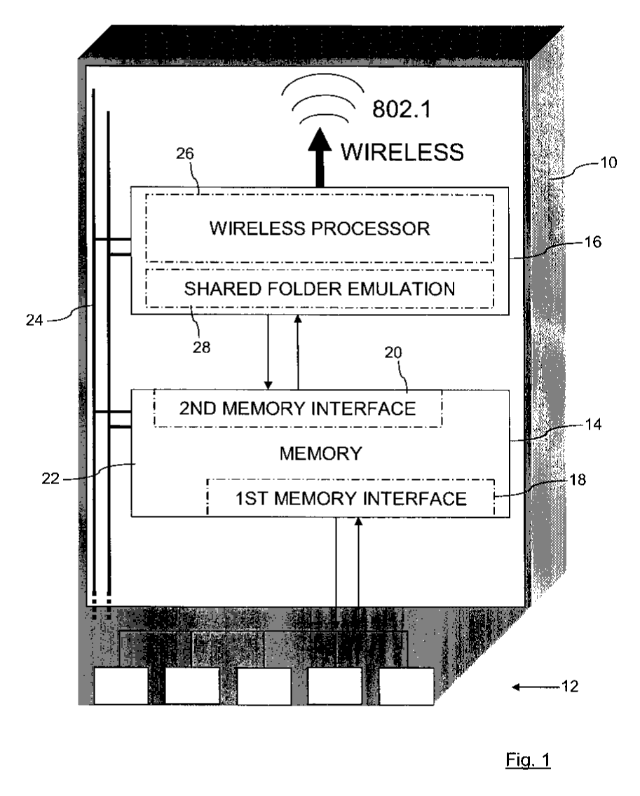

The device 10, shown in FIG. 1, is shaped like a conventional memory card (and can be provided in a number of popular formats, such as SD and MMC) and implements a suitable wireless standard such as 802.11. The device 10 will have some memory on board, for example 1+ GB. The device 10 also has a minimal computing environment on board (for example, a cut down version of Linux). This processing can implement Windows networking and provide the memory space of the card 10 as a network share to be accessed by any other machine on a local Windows network.

The device 10 comprises a physical interface 12, a memory module 14 and a wireless module 16. The memory module 14 comprises a first memory interface 18, a second memory interface 20 and a storage component 22. The physical interface 12 is connected to the first memory interface 18 and is arranged to support access to the storage component 22. The wireless module 16 is connected to the second memory interface 20 and is likewise arranged to support access to the storage component 22. The device 10 is arranged such that access to the wireless module 16 via the physical interface 12 is not possible.

The device 10 also includes power lines 24, which provide power to the memory module 14 and the wireless module 16. The power comes from a host device via the pins of the physical interface 12. The memory module 14 is accessible by any host device to which the memory card 10 is connected, in a purely conventional manner. The first memory interface 18 provides this access.

The access to the storage component 22 through the wireless module 16 and the second memory interface 20 is a read/write access, and allows remote access to the memory module 14. The wireless module 16 comprises a wireless processor 26, the wireless processor 26 arranged to manage wireless network participation. In addition, the wireless module 16 also comprises shared folder emulation via a component 28, which could be a lightweight version of Windows or a Linux equivalent (such as SAMBA). The wireless processor 26 can provide TCP/IP communication via its wireless capability and can include security via WEP, for example. The wireless processor 26 can obtain IP via dhcp.

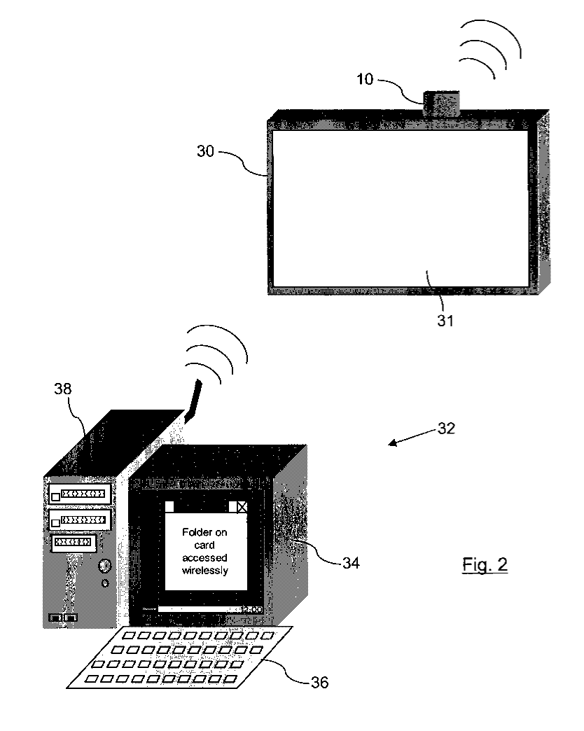

FIG. 2 is a schematic diagram of the device of FIG. 1, in use in a host device 30, and communicating with a wireless enabled computer 32. The memory card 10 locates in a slot in the host device 30. In this Figure, the host device 30 is shown as a digital photo frame 30. The host 30 is a device that has a display 31 that shows an image from the memory of the memory card 10. Depending on the functionality and settings of the digital photo frame 30, this image is fixed or can periodically change to another image stored by the memory card 10, in a predetermined manner.

The digital photo frame 30 has no wireless capability, and the use of a standard wireless card in the slot of the photo frame 30 will not enable any wireless functionality for the host device 30, because the necessary firmware and/or software is not present in the device 30. There is no way to import the necessary firmware into the device 30, as the internal structure is fixed at manufacture. The digital photo frame 30 is expecting a memory card in the slot, and has no functionality to accept any other card.

The memory card 10, an example of the inventive device described in this document, appears to the host device 30 as a conventional memory card. The physical interface 12 of the device 10 connects to the host device 30 in the normal way and the digital photo frame 30 can access the memory module 14. Any images stored by the storage component 22 of the memory module 14 are accessible by the digital photo frame 30 through the first memory interface 18. To the internal software of the digital photo frame 30, the memory card 10 is a conventional memory card, as the digital photo frame 30 does not detect the second memory interface 20 or the wireless module 16 of the device 10.

The computer 32 comprises a display 34, a keyboard 36 and a tower 38. The tower 38 includes conventional processing and storage capabilities, and, in addition, has wireless capability. Data is stored on and read from the memory card 10 without any interaction with the digital photo frame 30 (the host device of the memory card 10), by a user of the computer 32. The user of the computer 32, will detect the memory card as a component within their local wireless network and can add, copy and delete files stored in the storage component 22 of the card 10. In this way, the user can add new files to the memory card 10, which will then be accessible by the digital photo frame 30, for display on the display device 31 of the host device 30.

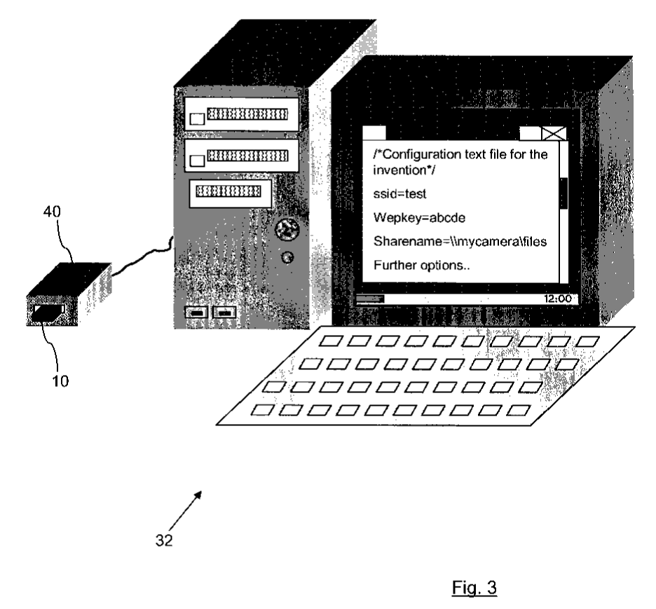

The device 10 also further comprises a configuration file stored by the storage component 22, the configuration file comprising information defining the access through the wireless module 16 to the storage component 22. FIG. 3 shows a schematic diagram of the computer 32 of FIG. 2, with a card reader 40 receiving the memory card 10. This is one way for the configuration file of the memory card 10 to be accessed.

For example, the device 10 would be used by being, firstly, purchased by the user, who places the device 10 into a memory card slot in the reader 40, which is connected to the computer 32 via a provided cable. Once the computer identifies the presence of the memory card 10 in the reader 40, then Windows/Linux shares the device 10 as a standard drive. The user can upload to the device 10 a text file (the configuration file), which contains the configuration settings for the user's wireless network, and also a share password. The management of the access through the wireless module 16 to the storage component 22 is likewise determined through the configuration file.

Once this has been completed, the device 10 is unplugged from the card reader 40 and put into the slot of the user's host device 30, where it draws power and provides the host device 30 with access to the memory module 14. As discussed above, the host device 30 is unaware of the networking abilities of the memory card 10. From the computer 32 with its wireless networking the user can now access the memory card space (used by the host device 30) and add files. These files can be used by the non-wireless host device 30.

As an alternative to the step above, of uploading the configuration file to the device 10, the device 10 could be shipped with a small piece of program code that stores the configuration settings for the memory card 10. In a preferred embodiment, these are stored in plain text format, as this means that if the host device 30 to which the memory card 10 is plugged into is a pocket PC, that host device 30 could also be used to modify the settings if the user were at another location away from their computer 32, and wished to access another wireless network.

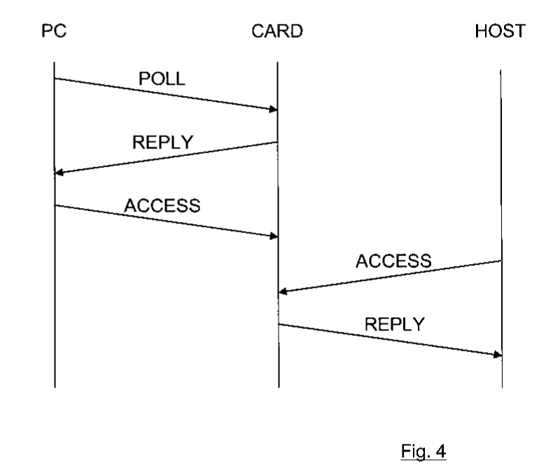

FIG. 4 shows a simple example of the communications taking place between the computer 32 (shown as PC in the Figure), the memory card 10 and the host device 30. The device 10 can be shipped with software for the computer 32 to poll for the device 10. When the host device 30 with the memory card 10 in its card slot is switched on, the computer can detect the card 10 and automatically refresh the files stored by the card 32, with some set of files the user has selected to be uploaded.

To achieve the polling/syncing, the first action is for the computer 32 to poll (through the local wireless network) for the existence of the card 10. This periodic poll will be received by the memory card 10 which replies according to the wireless protocol being used. Once this reply is received by the computer 32, then new files can be written to the storage component 22 of the memory module 14 on the device 10. The host device 30 can then access the memory of the card 10 which replies with the new files stored on the storage component 22.

Synchronisation can take place in much the same way as described above, but there would be a local copy of the files on the memory device 10 which the user could change to different files (add/delete/update) when the computer 32 notices the device 10 is turned on and in-range. The files would be synchronized. The device 10 can also support reverse subscribing where the memory device 10 could watch for the computer 31 becoming available and synchronize itself with a certain file share.

The memory card 10 could also be provided with short range wireless capability such as Bluetooth. The same device functionality is provided but using in addition (or instead) Bluetooth networking for lower power consumption.

Many different devices can take advantage of the functionality of the memory card 10. Digital picture frames such as the one shown in FIG. 2 (just like a real photo frame but with an LCD screen which changes the picture after a defined interval) with a large memory card; currently the memory card has to be removed and taken to a computer for uploading new files. This means a user's most up-to-date pictures are rarely on the digital picture frame. With the memory card 10 available, the card 10 could be automatically updated with any photos that the user has downloaded to their computer from their camera. Alternatively the card 10 could be manually updated remotely using wireless networking. Picture frames that do this are available but the vast majority do not offer this functionality, the memory card 10 brings this ability to all digital picture frames.

MP3 players such as used in living rooms, or mobile personal ones, can be used such that when the card 10 comes into range and is switched on it can be updated with the user's new MP3s from their computer. Additionally, files can be manually uploaded to the card 10 using the Windows shared folder on the memory card 10. A user can turn on their MP3 player to cycle to work listening to it. In the time they have put their shoes on and before they have gone out of the door, another two of the user's recent favourite tracks, that were found the previous night and placed on the user's computer have been downloaded to the card 10.

Car head unit MP3 players are now widely available, which have memory card slots. With the device 10, when a user turns the ignition on their car parked next to the house, it would receive updates of the new MP3 files from the user's home computer gradually over a number of days, and the MP3 player's collection will grow. Alternatively, the user could wait a couple of minutes before driving off, while synchronisation takes place.

In digital cameras, for example, their devices could be configures so that each time a user turns their camera on in their home, the hard disk of the user's computer could be kept synchronised with the pictures that they are taking. Even when a user is located by their computer, it is sometimes easier to administer a camera by the wireless connection (e.g. delete pictures).

1. A device comprising a physical interface, a memory module and a wireless module, the memory module comprising a first memory interface, a second memory interface and a storage component, the physical interface connected to the first memory interface and arranged to support access to the storage component, the wireless module connected to the second memory interface and arranged to support access to the storage component.

2. A device according to claim 1, wherein the device is arranged such that access to the wireless module via the physical interface is not possible.

3. A device according to claim 2, and further comprising a configuration file stored by the storage component, the configuration file comprising information defining the access through the wireless module to the storage component.

4. A device according to claim 2, wherein the access to the storage component through the wireless module and the second memory interface is a read/write access.

5. A device according to claim 2, wherein the wireless module comprises a wireless processor, the wireless processor arranged to manage wireless network participation.

6. A method of operating a device, the device comprising a physical interface, a memory module and a wireless module, the memory module comprising a first memory interface, a second memory interface and a storage component, the method comprising the steps of accessing the storage component of the memory module through the physical interface and the first memory interface of the memory module, and accessing the storage component of the memory module through the wireless module and the second memory interface.

7. A method according to claim 6, and further comprising preventing access to the wireless module via the physical interface.

8. A method according to claim 7, and further comprising storing a configuration file on the storage component, the configuration file comprising information defining the access through the wireless module to the storage component.

9. A method according to claim 7, wherein the access to the storage component through the wireless module and the second memory interface is a read/write access.

10. A method according to claim 7, wherein the wireless module comprises a wireless processor, the wireless processor managing wireless network participation.
